(19) United States
(12) Patent Application Publication
(10) Pub. No.: US 2011/0308920 A1
(43) Pub. Date: Dec. 22, 2011

(54) Lock-On Switch System for Hand Drill and Hand Drill having the Same

(75) Inventors: Xuedong Shi, Shanghai (CN); Xianbin Jiang, Hangzhou (CN); Juergen Wiker, Schaumburg, IL (US)

(73) Assignees: Robert Bosch GmbH, Stuttgart (DE); Bosch Power Tools (China) Co., Ltd., Hangzhou ,Zhejiang (CN)

(21) Appl. No.: 13/140,397

(22) PCT Filed: Dec. 17, 2008
(86) PCT No.: PCT/CN2008/073549

§ 371 Date: Sep. 7, 2011

(51) Int. Cl. H01H 9/20

(52) U.S. Cl. 200/43.17

(57) ABSTRACT

A lock-on switch system for hand drill includes a switch disposed in a switch housing for controlling the operation of the drill, a trigger which is adapted to be movable between a home position where the trigger turns off the switch and a pushed-in position where the trigger turns on the switch, a pivotable locking bar having a front end adapted to be engaged with the trigger for locking the trigger in the pushed-in position, a slidable actuator adapted for pushing the locking bar into engagement with the trigger, and biasing means adapted for applying a force on the locking bar in a direction of disengaging the locking bar from the trigger.

### TECHNICAL FIELD

The present invention relates to a lock-on switch system for hand drill and a hand drill having such a lock-on switch system.

### BACKGROUND ART

A hand drill generally has a switch disposed in the casing of the drill for controlling the operation of the drill. The switch may be actuated by a user via a trigger which can be locked in a triggered position by a lock-on mechanism. FIGS. 1-3 show such a switch. As shown in these figures, a switch is disposed in a switch housing 103 in a handle 101 of a hand drill. The switch is connected with a trigger 102 which is movable between a home position and a pushed-in position. That is to say, the trigger can be pushed in toward the switch to turn on the switch. A returning means pushes the trigger back in a direction toward its home position. A lock-on actuator 106 is provided for maintaining the trigger in its pushed-in position. The bar-like actuator extends in a direction generally perpendicular to the moving direction of the trigger and is movable between an engaged position and a released position. The trigger is formed with a hole 104 in its bottom side. When the trigger is pushed in, the upper end of the actuator is aligned with the hole. In this condition, the actuator can be pushed toward the trigger so that the upper end of the actuator inserts into the hole. Then, the pushing force applied on the trigger may be released so that the returning means pushes the trigger back a little, which causes the upper end of the actuator being engaged in the hole by means of friction force and preventing the trigger from moving further back. Now the actuator is in its engaged position, the trigger is locked in its pushed-in position by the actuator, and the switch maintains its turn-on state, as shown in FIG. 1.

To facilitate pushing the actuator into engagement with the trigger, the bottom end of the actuator is formed with a pushing button 107. A projection spring 105 is mounted around an upper portion of the actuator and is compressed between an upper stop 108 formed on the handle and a protrusion 109 formed on the actuator to apply a release force on the actuator tending to move the actuator out of the engagement with the trigger. For unlocking the trigger, the user may push in the trigger again, the engagement between the actuator and the trigger is removed and the actuator returns to its released position under the biasing force of the projection spring. Then, the user may release the trigger to permit the trigger to return to its home position under the pushing force of the returning means. The released position of the actuator is delimited by a lower stop 110, which is integrally formed on the handle below the upper stop 108 and comes into contact with the under side of the protrusion 109 during the releasing movement of the actuator to keep the actuator in its released position. The unlocked trigger is shown in FIGS. 2 and 3.

There are several drawbacks in the switch design described above. Specifically, when the trigger is in its locked state and the drill is operated, the lock-on actuator, which hangs up in the trigger, may be unintentionally released by itself from its engaged position. Thus, the locking reliability is low. Moreover, there are too many tolerance chains in this switch design so the tolerance accumulation is very large and the lock-on dimension cannot be defined accurately.

### SUMMARY OF INVENTION

An object of the present invention is to provide a hand drill having an improved lock-on switch system with high locking reliability and lock-on dimensional accuracy.

For achieving this task, according to one aspect of the invention, a lock-on switch system for hand drill comprises a switch disposed in a switch housing for controlling the operation of the drill; a trigger which is adapted to be movable between a home position where the trigger turns off the switch and a pushed-in position where the trigger turns on the switch; a pivotable locking bar having a front end adapted to be engaged with the trigger for locking the trigger in the pushed-in position; a slidable actuator adapted for pushing the locking bar into engagement with the trigger; and biasing means adapted for applying a force on the locking bar in a direction of disengaging the locking bar from the trigger.

In a preferred embodiment, the basing means comprises a projection spring arranged between the switch housing and the locking bar.

In a preferred embodiment, the locking bar has a pivotably mounted rear end and a front end that is bent up from the remaining part of the locking bar for engaging in a recess or hole formed in the under side of the trigger.

In a preferred embodiment, the lock-on switch system further comprises a second biasing means adapted for applying a force on the actuator in a direction away from the locking bar, wherein the upper end of the actuator is adapted to be in contact with the locking bar.

In a preferred embodiment, the upper end of the actuator is attached to the locking bar by means of a hinge pin, a plastic joint or a channel.

In a preferred embodiment, the basing means comprises a pull spring having one end hooked on the switch housing and another end hooked on the rear end of the locking bar.

In a preferred embodiment, the basing means comprises the locking bar which is formed of elastic material that permits the locking bar to pivot relative to the switch housing.

In a preferred embodiment, the basing means comprises a pair of magnets disposed on or in the locking bar and the switch housing respectively, the magnets being arranged with the poles of them having the same polarity facing each other.

In a preferred embodiment, the front end of the locking bar is formed as a hooking end having a hooking slot to be engaged with a mating edge formed in the underside of the trigger.

According to another aspect of the invention, a lock-on switch system for hand drill comprises a switch disposed in a switch housing for controlling the operation of the drill; a trigger which is adapted to be movable between a home position where the trigger turns off the switch and a pushed-in position where the trigger turns on the switch; a pivotable locking bar; an actuator adapted for pushing the locking bar into engagement with the trigger, wherein the front end of the locking bar is fixed to an upper portion of the actuator so that the locking bar and the actuator are pivotable together, and the upper end of the actuator is adapted to be engaged with the trigger for locking the trigger in the pushed-in position; and biasing means adapted for applying a force on the locking bar in a direction of disengaging the locking bar from the trigger.

According to yet another aspect of the invention, a hand drill having a lock-on switch system described above is provided.

According to the present invention, the lock-on mechanism comprises a pivotable locking bar and an actuator. The trigger can be locked in a higher reliability. Further, by achieving the lock-on function for a trigger of a hand drill by a locking bar and an actuator, tolerance chains can be reduced. Thus, the switch system is more robust and component parts like the switch housing and the lock-on actuator can have bigger tolerance, which means development time and tooling cost of the drill can be reduced.

### BRIEF DESCRIPTION OF THE DRAWINGS

The foregoing and other aspects of the invention will be understood and appreciated more fully from the following detailed description taken in conjunction with the following drawings, in which:

FIG. 1 is a schematic perspective view of a switch system according to prior art, wherein a trigger is in an unlocked home position;

FIG. 2 is a schematic perspective view of the switch system of FIG. 1, wherein the trigger is locked in a pushed-in position;

FIG. 3 is a partial plan view of the switch system of FIG. 1, wherein the trigger is locked in a pushed-in position;

FIG. 4 is a schematic plan view of a switch system according to an embodiment of the invention, wherein a trigger is in an unlocked home position;

FIG. 5 is a schematic plan view of the switch system of FIG. 4, wherein the trigger is locked in a pushed-in position;

FIG. 6 is a schematic plan view of a switch system according to another embodiment of the invention, wherein a trigger is in an unlocked home position;

FIG. 7 is a schematic plan view of a switch system according to yet another embodiment of the invention, wherein a trigger is in an unlocked home position;

FIG. 8 is an enlarged sectional view of the area “A” of FIG. 7; and

FIGS. 9 to 13 are schematic plan view of switch systems according to other embodiments of the invention, wherein in each case a trigger is in an unlocked home position.

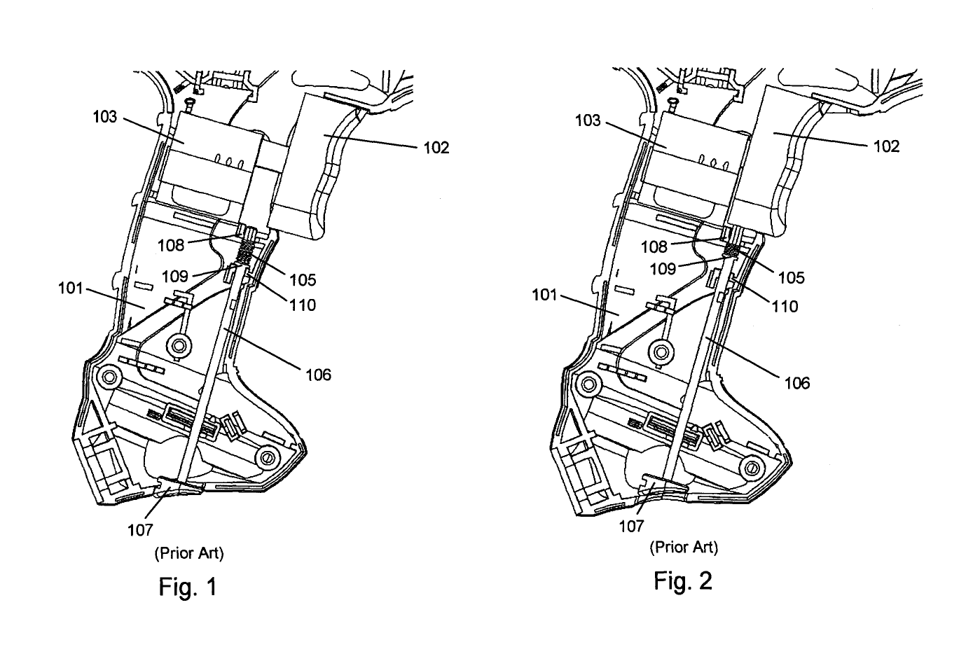

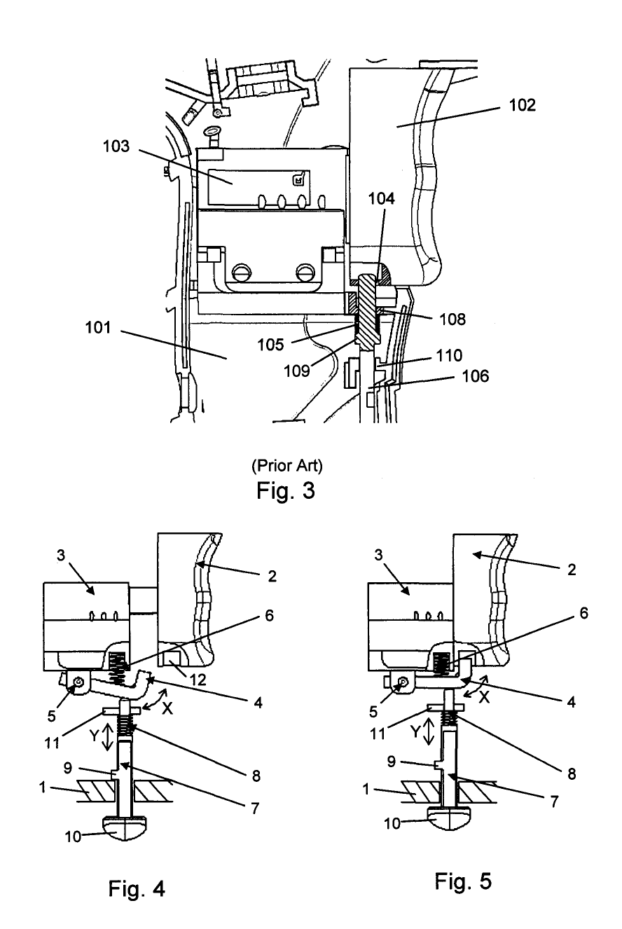

### DETAILED DESCRIPTION OF THE PREFERRED EMBODIMENTS

Now the preferred embodiments of the lock-on switch system for hand drill and the hand drill having such a lock-on switch system of the invention will be described with reference to the drawings.

FIGS. 4 and 5 show a switch system for hand drill according to an embodiment of the invention. The switch system comprises a switch (not shown) disposed in a switch housing 3 for controlling the operation of the drill. The switch is arranged in an upper portion of a handle of the drill and may be actuated by a user via a trigger 2, which is arranged in front of the switch and is horizontally movable between a home position and a pushed-in position. That is to say, the trigger can be pushed toward the switch to the pushed-in position to turn on the switch. The trigger 2 can be locked in the pushed-in position by a lock-on mechanism when the pushing force applied on the trigger is released. The trigger 2 can also be unlocked from the pushed-in position and go back to its home position by means of a returning means (not shown).

FIG. 4 shows the unlocking state of the lock-on mechanism, wherein the trigger 2 is in its unlocked home position and the switch is turned off. FIG. 5 shows the locking state of the lock-on mechanism, wherein the trigger 2 is locked in its pushed-in position and the switch is turned on.

The lock-on mechanism mainly comprises a pivotable locking bar 4 which is adapted to lock the trigger 2 in its unlocked home position and an actuator 7 which drives the locking bar into the locking state.

As shown in FIGS. 4 and 5, the locking bar 4 is provided in a position below the trigger 2 and the switch housing 3. The locking bar 4 has a rear end that is pivotably mounted to the handle or to the switch housing 3 via a pivot pin 5 and a front end that is bent up from the remaining part of the locking bar 4. The front end forms an engaging part to be engaged in a recess or hole 12 formed in the under side of the trigger 2. The locking bar 4 is pivotable in a direction “X” as shown in FIGS. 4 and 5 around the pivot pin 5.

In the switch system for hand drill shown in FIGS. 4 and 5, a projection spring 6 is compressed between the under side of the switch housing 3 and a portion of the locking bar 4 which is located between the pivot pin 5 and the front end of the locking bar 4. The recess or hole 12 formed in the under side of the switch housing 3 is adapted for receiving the upper end of the projection spring 6. The lower end of the projection spring 6 abuts against the locking bar 4 and normally pushes the locking bar 4 in a direction away from the switch housing 3 and the trigger 2.

The actuator 7 is disposed below the locking means and extends upwardly from the bottom end of the handle in a direction substantially perpendicular to the moving direction of the trigger 2. The actuator 7 is vertically movable (slidable) in a direction “Y” as shown in FIGS. 4 and 5. In particular, the lower end of the actuator 7 is inserted from above through a hole formed in a bottom wall portion 1 of the handle and exposed to the outside. A pushing button 10 is then attached to the lower end of the actuator 7. A protrusion 9 is formed on or attached to the periphery of the actuator 7. Thus the bottom wall portion 1 is limited between the protrusion 9 and the pushing button 10. An actuator spring 8 is mounted around an upper portion of the actuator 7 and is compressed between a stop 11 which is integrally formed on or attached to the handle and a shoulder of the actuator to apply a release force on the actuator tending to move the actuator in a direction away from the locking bar. The upper end of the actuator 7 is adapted to be in contact with the locking bar 4 at a position between the pivot pin 5 and the front end of the locking bar 4.

In the unlocking state of the lock-on mechanism as shown in FIG. 4, the locking bar 4 is in its lowermost position under the pushing force of the projection spring 6. The lowermost position of the locking bar 4 is delimited by the contact of the locking bar with the upper end of the actuator 7. On the other hand, the actuator 7 is in its lowermost position under the pushing force of the actuator spring 8 and the urging force from the locking bar 4. The lowermost position of the actuator 7 is delimited by the contact of the protrusion 9 with the bottom wall portion 1.

When it needs to turn on the switch, a user may push the trigger 2 inwardly toward the switch housing 3 to let the trigger reach its pushed-in position where the front end of the locking bar 4 is aligned with the hole 12. In this condition, the actuator 7 is pushed upwardly in the direction “Y” so as to drive the locking bar 4 pivoting upwardly in the direction “X” until the front end of the locking bar 4 inserts into the hole 12. Then, the pushing force applied on the trigger 2 may be released, so that the returning means pushes the trigger 2 back a little, which causes the front end of the locking bar 4 being engaged in the hole 12 by means of friction force between the front end of the locking bar 4 and the trigger 2, thus preventing the trigger 2 from moving further back. Now the trigger 2 is locked in its pushed-in position by the locking bar 4, and the switch maintains its turn-on state, as shown in FIG. 5. Then, the pushing force applied on the actuator 7 (pushing button 10) can be removed and the actuator 7 slides toward its lowermost position under the pushing force of the actuator spring 8. Now the trigger 2 is locked only by the locking bar 4.

When it needs to turn off the switch, the user may push the trigger 2 inwardly toward the switch housing 3 a little, and by which action, the friction force between the front end of the locking bar 4 and the trigger 2 disappears and the locking bar 4 pivots toward its lowermost position under the pushing force of the projection spring 6. Then the trigger may return to its home position by means of the returning means, and the switch is turned off, as shown in FIG. 4.

As described, in the embodiment of the invention as shown in FIGS. 4 and 5, the lock-on mechanism for the trigger is formed by the locking bar 4 and the actuator 7. Thus, the lock bar 4 is not likely to be disengaged from the trigger 2 by itself, which results in an improvement in the locking reliability. Meanwhile, since the trigger is locked only be the locking bar which in turn is actuated by the actuator, tolerance chains of the lock-on mechanism can be reduced, which may provide benefits in the design and manufacture of the switch system.

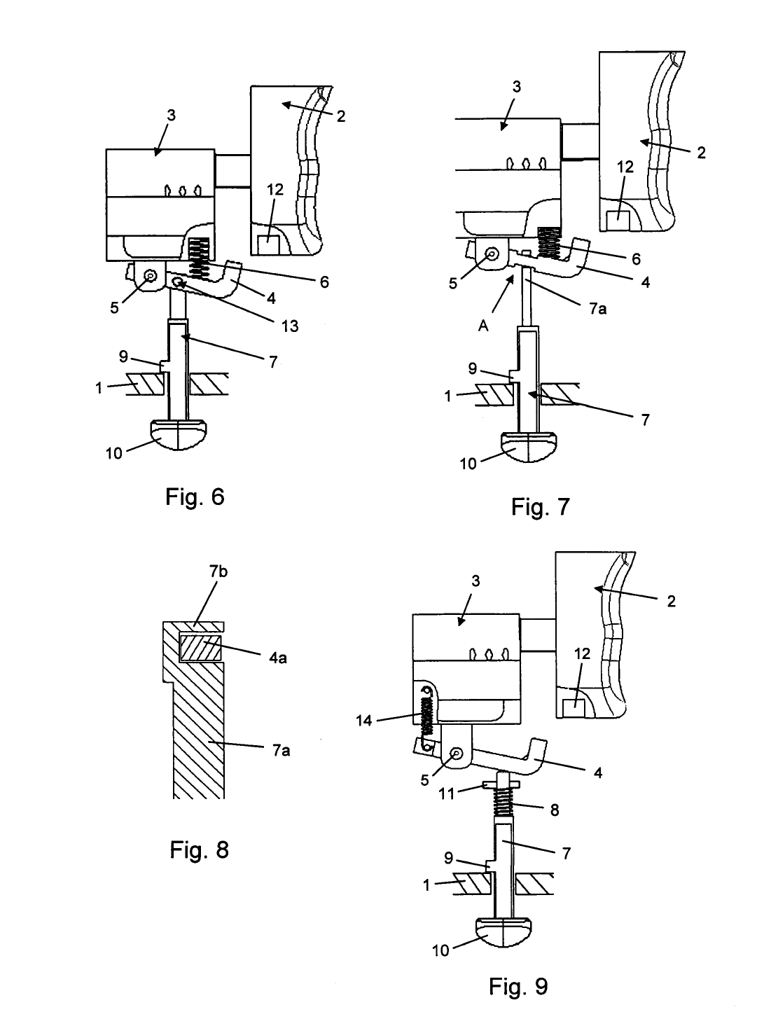

Other preferred embodiments of the switch system of the invention will be described now with reference FIGS. 6-13. Like elements or parts will be designated by the same reference numerals throughout the drawings, and their detailed explanation will be omitted.

In the switch system for hand drill shown in FIG. 6, the upper end of the actuator 7 is hinged to the locking bar 4 at a position between the pivot pin 5 and the front end of the locking bar 4 by a hinge pin 13 so that the actuator 7 is always connected with the locking bar 4. When the locking bar 4 pivots toward its lowermost position under the pushing force of the projection spring 6, the actuator 7 is driven to move down by the locking bar 4. In this embodiment, the actuator spring 8 and the stop 11 may be omitted (although it is not necessary to omit them). Other components of the switch system shown in FIG. 6 are similar to that of the embodiment shown in FIGS. 4 and 5. It is appreciated that the same effects can be obtained by the embodiment shown in FIG. 6 as that shown in FIGS. 4 and 5.

The embodiment shown in FIG. 7 is similar to that of FIG. 6. However, in the switch system for hand drill shown in FIG. 7, the upper portion 7a of the actuator 7 is formed with a channeled portion 7b having an opened channel for receiving an attaching portion 4a of the locking bar 4. As shown in FIG. 7, the attaching portion 4a may be thinner than the remaining portions of the locking bar 4. The open channel in the channeled portion 7b is sized and/or shaped to accommodate the pivot movement of the attaching portion 4a therein. In this way, the actuator 7 is attached to the locking bar 4. The attachment between them is more clearly shown in FIG. 8. In this embodiment, just like that shown in FIG. 6, the actuator spring 8 and the stop 11 may be omitted (although it is not necessary to omit them). Other components of the switch system shown in FIG. 7 are similar to that of the embodiment shown in FIG. 6, and the same effects can be obtained by the embodiment shown in FIG. 7 as previous ones.

In the switch system for hand drill shown in FIG. 9, the projection spring 6 which is adopted in previous embodiments is replaced by a pull spring 14. The upper end of the pull spring 14 is hooked on the switch housing 3, and the lower end is hooked on the rear end of the locking bar 4. The rear end of the locking bar 4 extends backwardly beyond the pivot pin 5 so that the pivot pin 5 is between the hooking point on the rear end of the locking bar 4 and the front end of the locking bar 4. The locking bar 4 may pivot toward its lowermost position under the pulling force of the pull spring 14. Other components of the switch system shown in FIG. 9 are similar to that of the embodiment shown in FIGS. 4 and 5, and the same effects can be obtained by the embodiment shown in FIG. 9 as previous ones.

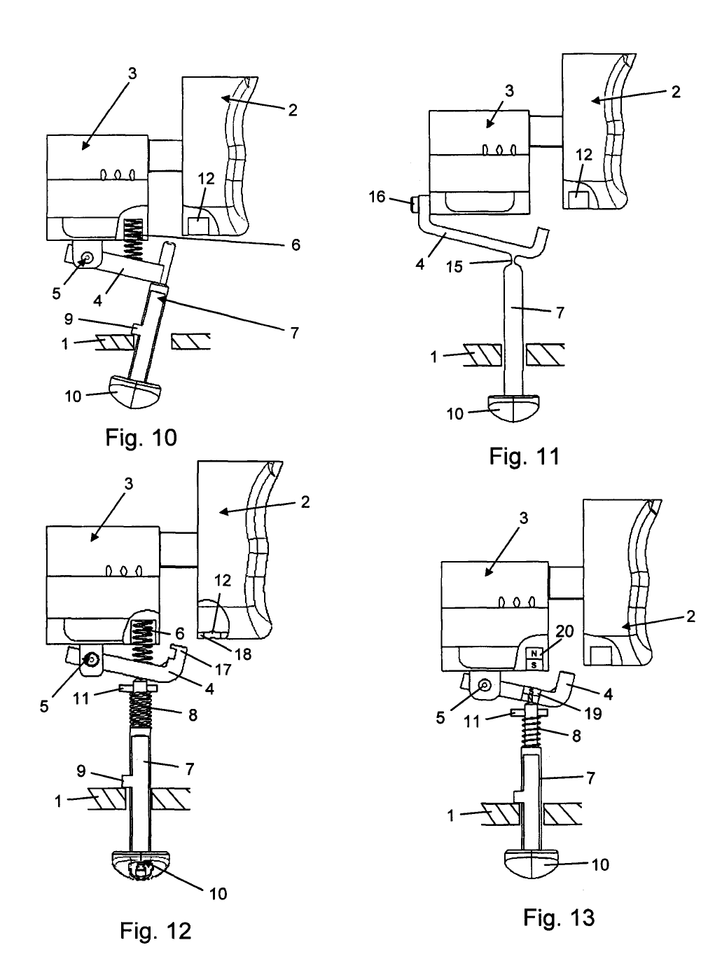

In the switch system for hand drill shown in FIG. 10, the locking bar 4 is straight, that is to say, the front end of the locking bar 4 is not bent up as in previous embodiments. Meanwhile, the front end of the locking bar 4 is fixed to the upper portion of the actuator 7 so that the licking bar 4 and the actuator 7 are pivotable together. The upper end of the actuator 7 is adapted to be engaged in the hole or recess 12 formed in the underside of the trigger 2 by friction force. Other components of the switch system shown in FIG. 10 are similar to that of the embodiment shown in FIGS. 6 and 7, and the same effects can be obtained by the embodiment shown in FIG. 10 as previous ones.

In the switch system for hand drill shown in FIG. 11, the locking bar 4 is formed of a plastic material which has elasticity. The rear end of the locking bar 4 is fixed to the switch housing 3 by a screw 16. The upper end of the actuator 7 is connected with the locking bar 4 via a plastic hinge 15. The plastic hinge 15 is located near the front bent up end of the locking bar 4. The locking bar 4 is pivotable by means of its elasticity. Specifically, the locking bar 4 can be pushed up by the actuator 7 so that the front end of the locking bar is engaged, by friction force, in the hole or recess 12 formed in the underside of the trigger 2. When the engagement is released and there is no pushing force applied to the locking bar 4 from the actuator 7, the locking bar 4 will return back to the position shown in FIG. 11 under its elasticity. The actuator 7 is slidable as in the embodiments shown in FIGS. 4-9, while the plastic hinge 15 permits the locking bar 4 to pivot relative to the actuator 7. The actuator 7 may be formed of the same or different plastic material from that of the locking bar 4. In this embodiment, the projection spring 6 (or the pull spring 14) and the actuator spring 8 may be omitted (although it is not necessary to omit them). Other components of the switch system shown in FIG. 11 are similar to that of the previous embodiments, and the same effects can be obtained by the embodiment shown in FIG. 11 as previous ones.

The embodiment shown in FIG. 12 is similar to that of FIGS. 4 and 5. However, in the switch system for hand drill shown in FIG. 12, the front bent up end of the locking bar 4 is formed as a hooking end 17 having a hooking slot. The hole 12 in the trigger 2 has a mating edge 18 to be snapped in the hooking slot of the hooking end 17. In this way, the engagement between the locking bar 4 and the trigger 2 can be enhanced. Other components of the switch system shown in FIG. 12 are similar to that of the embodiment shown in FIGS. 4 and 5. The same effects can be obtained by the embodiment shown in FIG. 12 as that shown in FIGS. 4 and 5.

The embodiment shown in FIG. 13 is similar to that of FIGS. 4 and 5. However, in the switch system for hand drill shown in FIG. 13, the projection spring 6 is replaced by a pair of magnets 19 and 20 disposed on or in the locking bar 4 and the switch housing 3 respectively. The magnets 19 and 20 are arranged with the poles of them having the same polarity facing each other. In FIG. 13, S poles of magnets 19 and 20 face each other. Alternatively, N poles of magnets 19 and 20 may face each other. In this way, the magnets 19 and 20 will create a repulsive force between them for urging the locking bar 4 in a direction away from the switch housing 3. Other components of the switch system shown in FIG. 13 are similar to that of the embodiment shown in FIGS. 4 and 5. The same effects can be obtained by the embodiment shown in FIG. 13 as that shown in FIGS. 4 and 5.

Although different embodiments of the invention are shown in the drawings, the features of these embodiments may be adopted in combination or substitution. For example, the hooking end 17 shown in FIG. 12, the magnets 19 and 20 shown in FIG. 13 and the like may be used in other embodiments.

Further, although the invention is illustrated and described herein with reference to specific embodiments, the invention is not intended to be limited to the details shown. Rather, various modifications may be made in the details within the scope and range of equivalents of the claims and without departing from the invention.

1. A lock-on switch system for hand drill comprising:
a switch disposed in a switch housing for controlling the operation of the drill;
a trigger which is adapted to be movable between a home position where the trigger turns off the switch and a pushed-in position where the trigger turns on the switch;
a pivotable locking bar having a front end adapted to be engaged with the trigger for locking the trigger in the pushed-in position;
a slidable actuator adapted for pushing the locking bar into engagement with the trigger; and
a biaser configured to apply a force on the locking bar in a direction of disengaging the locking bar from the trigger.

2. The lock-on switch system according to claim 1, wherein the biaser comprises a projection spring arranged between the switch housing and the locking bar.

3. The lock-on switch system according to claim 1, wherein the locking bar has a pivotably mounted rear end and a front end that is bent up from the remaining part of the locking bar for engaging in a recess or hole formed in the under side of the trigger.

4. The lock-on switch system according to claim 1, further comprising a second biaser configured to apply a force on the actuator in a direction away from the locking bar, wherein the upper end of the actuator is adapted to be in contact with the locking bar.

5. The lock-on switch system according to claim 1, wherein the upper end of the actuator is attached to the locking bar by a hinge pin, a plastic joint or a channeled portion.

6. The lock-on switch system according to claim 1, wherein the biaser comprises a pull spring having one end hooked on the switch housing and another end hooked on the rear end of the locking bar.

7. The lock-on switch system according to claim 1, wherein the biaser comprises the locking bar which is formed of elastic material that permits the locking bar to pivot relative to the switch housing.

8. The lock-on switch system according to claim 1, wherein the biaser comprises a pair of magnets disposed on or in the locking bar and the switch housing respectively, the magnets being arranged with the poles of them having the same polarity facing each other.

9. The lock-on switch system according to claim 1, wherein the front end of the locking bar is formed as a hooking end having a hooking slot to be engaged with a mating edge formed in the underside of the trigger.

10. A lock-on switch system for hand drill comprising:
a switch disposed in a switch housing for controlling the operation of the drill;
a trigger which is adapted to be movable between a home position where the trigger turns off the switch and a pushed-in position where the trigger turns on the switch;
a pivotable locking bar;
an actuator adapted for pushing the locking bar into engagement with the trigger, wherein the front end of the locking bar is fixed to an upper portion of the actuator so that the locking bar and the actuator are pivotable together, and the upper end of the actuator is adapted to be engaged with the trigger for locking the trigger in the pushed-in position; and
a biaser configured to apply a force on the locking bar in a direction of disengaging the locking bar from the trigger.

11. A hand drill comprising:
a switch disposed in a switch housing for controlling the operation of the drill;
a trigger which is adapted to be movable between a home position where the trigger turns off the switch and a pushed-in position where the trigger turns on the switch;
a pivotable locking bar having a front end adapted to be engaged with the trigger for locking the trigger in the pushed-in position;
a slidable actuator adapted for pushing the locking bar into engagement with the trigger; and
a biaser configured to apply a force on the locking bar in a direction of disengaging the locking bar from the trigger.
